(19) United States
(12) Patent Application Publication
(10) Pub. No.: US 2013/0264839 A1
(43) Pub. Date: Oct. 10, 2013

(54) VEHICLE FLOORING SYSTEM

(71) Applicants: William E. Stimel, JR., Alexandria, OH (US); Logan E. Mullinix, New Albany, OH (US); James Haylett, Pataskala, OH (US)

(72) Inventors: William E. Stimel, JR., Alexandria, OH (US); Logan E. Mullinix, New Albany, OH (US); James Haylett, Pataskala, OH (US)

(73) Assignee: CVG MANAGEMENT CORPORATION, New Albany, OH (US)

(21) Appl. No.: 13/626,468

(22) Filed: Sep. 25, 2012

Related U.S. Application Data
(63) Continuation-in-part of application No. 13/420,112, filed on Mar. 14, 2012.

(51) Int. Cl. B62D 25/20; B29D 99/00

(52) U.S. Cl. CPC B62D 25/2072; B29D 99/0057
USPC 296/39.3; 264/309; 264/279

(57) ABSTRACT

A vehicle spray flooring system is provided that includes a single-sided mold component and a spray application component that facilitates application of a liquefied mixture into the single-sided mold. The application of the liquefied mixture results in a vehicle flooring product, whereby the liquefied mixture.

### CROSS-REFERENCE TO RELATED APPLICATIONS

This application is a Continuation-in-Part of pending U.S. patent application Ser. No. 13/420,112 entitled “VEHICLE FLOORING SYSTEM” filed on Mar. 14, 2012 and claims the benefit of U.S. Provisional Patent application Ser. No. 61/453,436 entitled “VEHICLE FLOORING SYSTEM” and filed on Mar. 16, 2011. The entireties of the above-noted applications are incorporated by reference herein.

### ORIGIN

The subject innovation relates generally to the field of vehicle interior flooring systems and more particularly, to systems and methods of manufacture and molding of vehicle interior flooring material and insulation systems.

### BACKGROUND

Today, many products are manufactured by way of molding. The process usually involves shaping pliable raw material using a rigid frame or model called a “pattern,” also oftentimes referred to as a “mold.” A “mold” often refers to a hollowed-out block that can be filled with a liquefied plastic, glass, metal, ceramic materials, or the like. In manufacturing, the liquid hardens or “sets” inside the mold, adopting the shape of the mold's inner surface. Once hardened, a release agent is typically used to effect removal of the hardened/set substance from the mold.

Injection molding is a manufacturing process for producing items from materials such as thermoplastic and thermosetting plastic materials. In most instances, the thermoplastic or thermosetting plastic material is inserted into a heated container, mixed, and forced (or injected) into a mold cavity often using a two-part mold. Thereafter, the material cools and hardens to the configuration of the mold cavity.

Molds are most often constructed from metal, usually either steel or aluminum, and precision-machined to form the features of the desired part. Injection molding is widely used for manufacturing a variety of parts, from the smallest component to a vehicle flooring system (i.e. floor mats) to entire vehicle body panels. Another form of molding is referred to as reaction injection molding or RIM. This type of molding is similar to injection molding however, thermosetting polymers are used in place of plastics. These thermosetting polymers require a curing reaction to occur within the two-part mold. Common vehicle components manufactured via RIM include bumpers, air spoilers, and fenders.

In addition, producing acoustical insulators and liners for vehicle applications via a mold and molding process to attenuate sound have been developed with limited success. These insulators typically rely upon both sound absorption, i.e. the ability to absorb incident sound waves and transmission loss, and the ability to reflect incident sound waves, in order to provide sound attenuation.

### SUMMARY

The following presents a simplified summary of the specification in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, discloses a vehicle flooring system that includes a single-sided mold component and a spray application component that facilitates application of a liquefied mixture into the single-sided mold, wherein the application results in a vehicle flooring product.

In yet another aspect, the innovation discloses the use of a foil or other type of heat deflector that can be molded into the flooring system that deflects heat away from a vehicle's occupant compartment.

In yet another aspect, the innovation disclosed and claimed herein, in one aspect thereof, discloses an acoustical performance of a double wall sound system expressed in terms of sound transmission loss (STL). The innovation utilizes design techniques that generate example embodiments including a wear surface layer, a mass-filled layer, and a de-coupler layer. The innovation discloses factors that influence the performance of the sound system for use in the commercial vehicle industry and describes methods to determine which factors have the most influence on the STL performance and optimal design configurations.

In another aspect, the innovation discloses a method of geometric shapes, surface treatment and composite manufacturing to create reduced localized stiffness and low strain energy for improve acoustic reduction and barrier properties of a combined double wall constrained layer system.

In another aspect, the innovation discloses a molded acoustic and vibration insulator or liner for a vehicle is provided that includes a first layer a second layer disposed on the first layer. The second layer has a textured bottom surface to facilitate attenuation of sound and/or vibration.

In yet another aspect, the innovation discloses a mold that facilitates the manufacture of a molded acoustic and vibration insulator or liner for a vehicle is provided that includes a first mixture a second mixture disposed on the first mixture. The second mixture has a textured bottom surface to facilitate attenuation of sound and/or vibration.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates an example block diagram of a flooring manufacturing system for a vehicle in accordance with aspects of the innovation.

FIG. 2 illustrates an example flow chart of procedures that facilitate manufacturing a flooring product for a vehicle in accordance with aspects of the innovation.

FIG. 3 illustrates a top perspective view of an example single-sided mold in accordance with aspects of the innovation.

FIG. 4 illustrates an example flooring product manufactured in accordance with aspects of the innovation.

FIG. 5 illustrates a perspective view of another example embodiment of a conventional commercial vehicle floor mat in accordance with an aspect of the innovation.

FIG. 6 illustrates a perspective view of a molded vehicle floor mat incorporating sound and vibration attenuation in accordance with an aspect of the innovation.

FIG. 7 illustrates a cross-section view of an example molded floor mat in accordance with an aspect of the innovation.

FIG. 8 is an illustration of a step-by-step process of forming the molded vehicle floor mat of FIG. 6 in accordance with an aspect of the innovation.

FIG. 9 illustrates an example flow chart of procedures that facilitate manufacturing the molded vehicle floor mat of FIG. 6 in accordance with aspects of the innovation.

FIG. 10 is a graphical representation demonstrating the improvement in sound transmission losses for the innovative floor mat in accordance with an aspect of the innovation.

FIGS. 11-14 are graphical representations of sound transmission loss responses and main effect plots in accordance with an aspect of the innovation.

FIG. 15 is another example embodiment of a molded floor mat having a texturized bottom surface in accordance with an aspect of the innovation.

FIG. 16 is an example embodiment of a perfing tool used to create an uneven bottom surface of a molded flooring mat in accordance with an aspect of the innovation.

FIG. 17 is an illustration of a schematic block diagram of an exemplary computing system in accordance with the innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

While specific characteristics are described herein (e.g., thickness), it is to be understood that the features, functions and benefits of the innovation can employ characteristics that vary from those described herein. These alternatives are to be included within the scope of the innovation and claims appended hereto.

As described above, in a reaction injection molding (RIM) process, two parts of a polymer are mixed together and subsequently injected into a mold under high pressure, e.g., using an impinging mixer. The mixture is left in the mold for a period of time sufficient for the mixture to expand and for the curing reaction to complete.

Additionally, if desired, reinforcing agents can be added to the mixture prior to injection. This process is often referred to as reinforced reaction injection molding (RRIM). For example, reinforcing agents such as glass fibers can be added into the mixture so as to enhance strength of the final product. For this reason, it will be appreciated that RRIM is often used to produce rigid automotive panels. A subset of RRIM is structural reaction injection molding (SRIM), which uses fiber mesh as a reinforcing agent. In accordance with SRIM, the fiber mesh is first arranged in the mold and then the polymer mixture is injection molded onto the mesh.

Traditionally, flooring products (e.g., mats) for vehicles were manufactured using adhesives and glues to bond stock materials together. These materials were later die-cut or overlayed with an injected top surface. To the contrary, the innovation described herein, in aspects thereof, provides for a spray-applied top surface. In particular embodiments, the spray “skin” may employ a mixture of urethane and polyurea. One particular aspect employs a mixture of urethane and polyurea (e.g., approximately 5% urethane and 95% polyurea) in the spray mixture. In another embodiment, the spray mixture may employ a 100% blend of urea that includes a percentage of barium sulfate (BaSO4). The barium sulfate is used as a filler and sound deadening material. Thus, it is to be appreciated that the composition of the spray mixture may be any suitable mixture that facilitates the objectives of the innovation disclosed herein.

The novel manufacturing system (and method) of the innovation provides for clarity in the finished product aesthetics above that of conventional manufacturing techniques. In particular aspects, the innovation provides for in-molded features and components such as textures and logos as desired. For example, a desired logo or other treatment (e.g., grain type) can be provided on the A-side of the flooring product. In addition, localized areas of the A-side can include carpet. Once the carpet is in place the spray mixture can be applied in a normal process with a less amount (approximately 1.0-1.5 mm) being applied to the carpeted areas. This will create a bond of skin to the carpet and creates a barrier over the B-side of the carpet so foam will not transfer through during the reaction.

Additionally, the innovation can provide for variable thickness in the flooring product. It will be appreciated that this variable thickness can enhance wear-ability as well as assist in audible and thermal reduction, e.g., from road noise and engine/exhaust components respectively.

In accordance with the innovation, a spray can be employed to manufacture a flooring product, such as but not limited to a floor mat. The innovation further employs a single-sided mold that has a draft angle of approximately 90 degrees to facilitate the removal of the finished flooring product. In other words, the method can be described using the perspective of zero degrees as a shear condition. In aspects, the single-sided mold includes a vertical wall ninety degrees to the main horizontal surface. In conventional injection processes, a male/female tool is used, which with zero degrees, generates shear upon the vertical portion. The innovation alleviates this effect by employing a spray application process. In other words, the spray process uses a single-sided tool for this application, which lends to greater flexibility in design and alleviates from shearing. Accordingly, endless three-dimensional capabilities are possible with this unique manufacturing system and method.

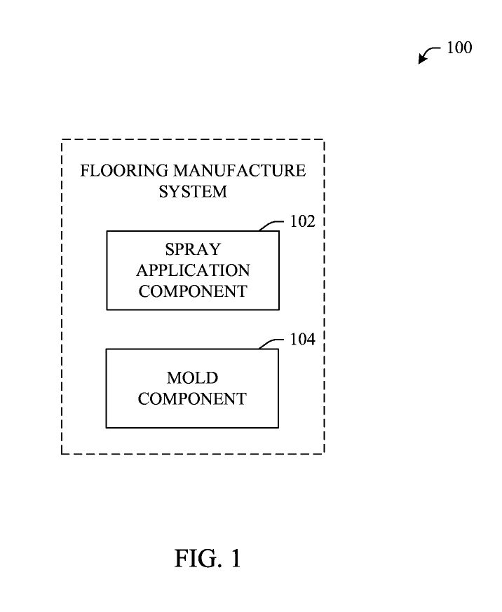

Referring to FIG. 1, a block diagram of a flooring manufacturing system 100 to manufacture a flooring product (e.g., a floor mat) is shown in accordance with aspects of the innovation. As shown, the system 100 can include a spray application component 102 and a mold component 104. The spray application component 102 can be used to apply a liquefied material into a cavity of a single-sided mold. For example, the spray application component 102, as shown, can be used to apply a liquefied spray mixture.

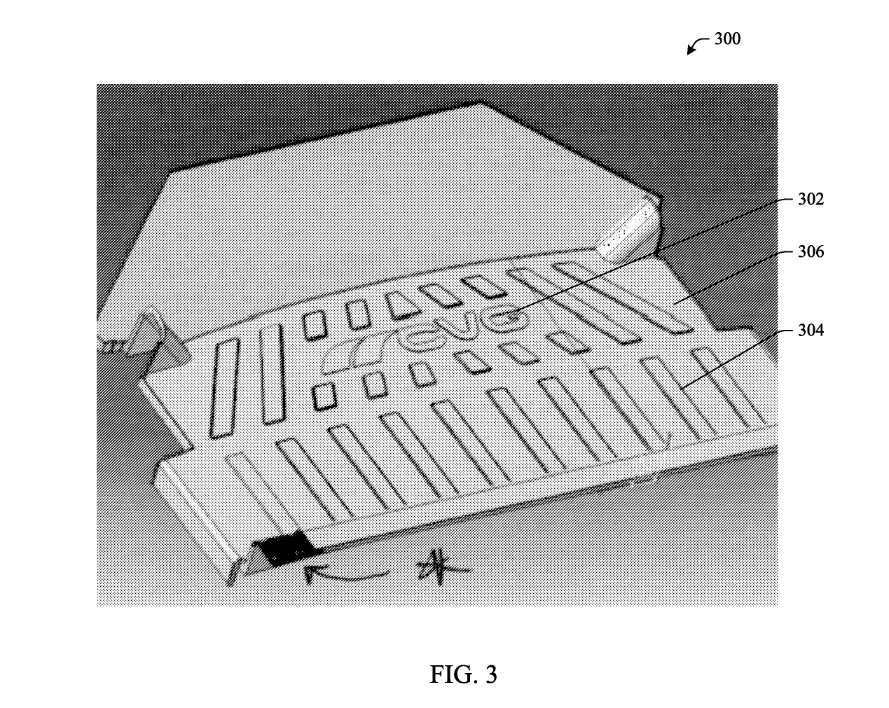

The mold component 104 can be comprised of a single-sided mold. In addition, the single-sided mold can include surface treatments that will be transferred to a top surface (A-side) of the flooring product to enhance aesthetics or functionality of the molded product. For example, a logo, ridges, a grain type structure, etc. can be applied to the top surface of the single-sided mold, described further below in reference to FIG. 3.

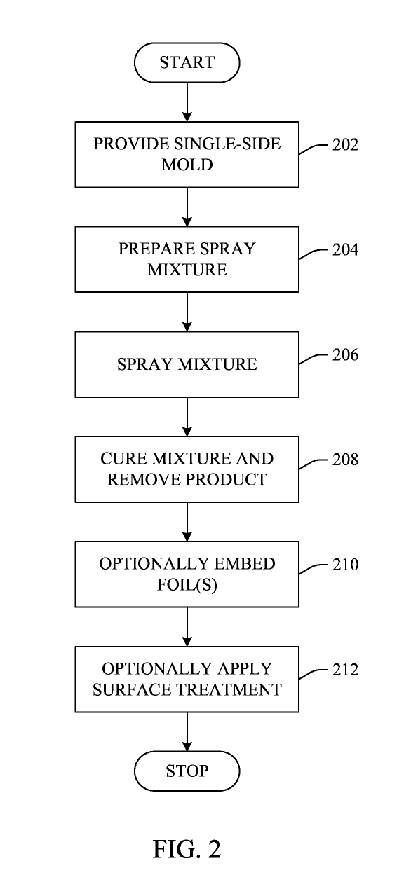

FIG. 2 illustrates a methodology of manufacturing a flooring product in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. Moreover, not all illustrated acts may be required to implement a methodology in accordance with the innovation.

At 202, a single-sided mold is provided. It is to be understood that because the novel flooring manufacturing system employs a spray component described above, a single-sided (or single-part) mold is all that is required to manufacture the flooring product. At 204, a spray mixture is prepared to apply to the single-sided mold. At 208, the spray mixture is cured for a predetermined period of time and removed from the single-sided mold.

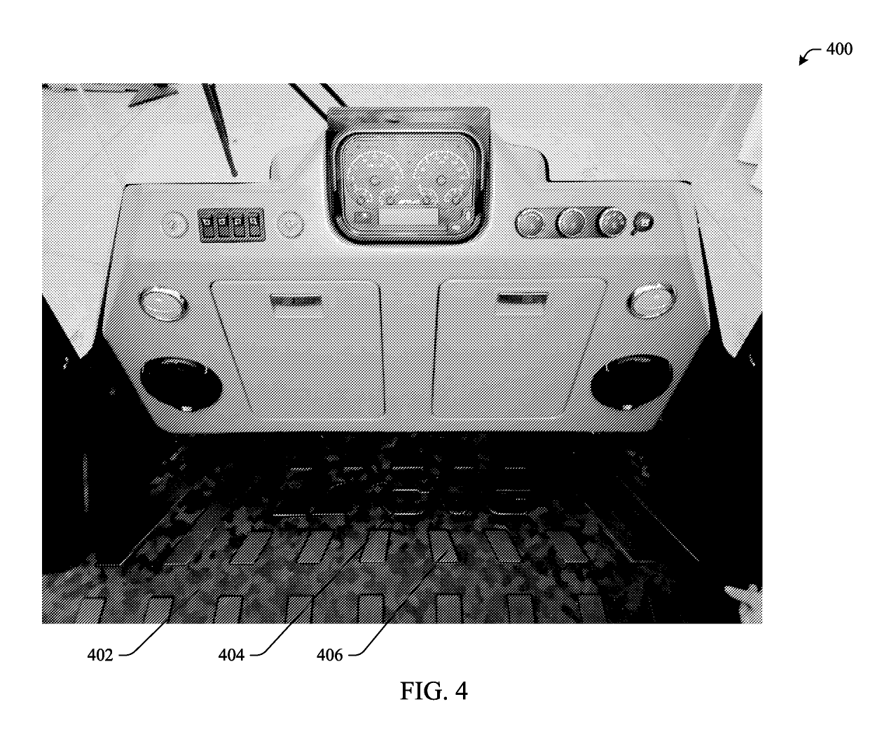

It will be understood that optional acts can take place at 210 and 212. For example, at 210, a foil(s) or other temperature deflector/insulator can be embedded into the flooring product. It will be understood that a molded-in foil can enhance occupant comfort by blocking or shielding heat from entering the vehicle, e.g., cab of a long haul truck. Additionally, at 212, a surface treatment (e.g., logo, pattern such as graining or logo) can be applied so as to enhance aesthetics as well as functionality of the flooring product, see FIGS. 3 and 4. Still further, as described supra, because the liquefied mixture material is sprayed, the thickness can be varied as desired or appropriate for a particular application.

FIG. 3 is an example illustration of a single-sided mold 300 in accordance with an aspect of the innovation. As described above, the mold 300 can include surface treatments, such as but not limited to, a logo 302 and/or a grain type surface 304 (e.g., ridges) applied to a top surface 306 of the mold 300. To facilitate the removal of the flooring product after application of the liquefied mixture, the single-sided mold 300 has a draft angle of approximately 90 degrees.

FIG. 4 is an example illustration of a vehicle 400 incorporating a finished flooring product 402 in accordance with an aspect of the innovation. In the illustrated example, the flooring product 402 includes surface treatments comprised of a logo 404 and ridges 406 transferred from the top surface 306 of the mold 300, shown in FIG. 3. As mentioned above, the surface treatments enhance both the aesthetics and the functionality of the flooring product 402.

As described herein, the spray mixture can be a blend of urea that includes barium sulfate, a combination of urethane (e.g., approximately 5%) and polyurea (e.g., approximately 95%), etc. Those skilled in the art will understand that polyurea is a type of elastomer that is derived from the reaction product of an isocyanate component and a synthetic resin blend component through step-growth polymerization. In accordance with the innovation, the mixture can be sprayed into a mold (e.g., single-part mold) or directly upon a floor surface (e.g., metal, backing material). As described herein, when sprayed into a mold, it will be appreciated that, because a single-sided mold is used, shear can be alleviated as would be present in a conventional two-part molding process.

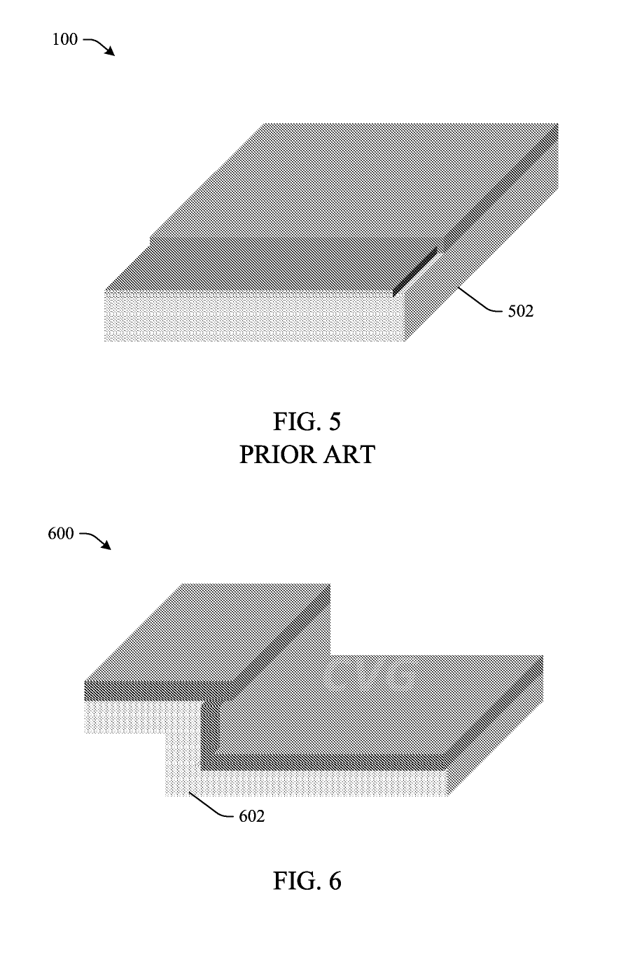

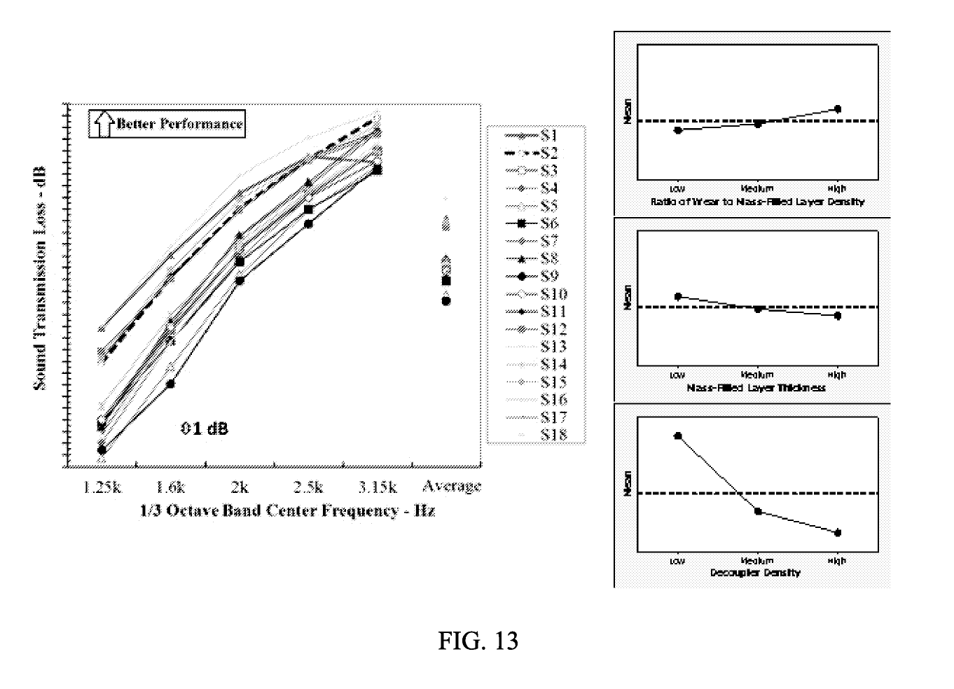

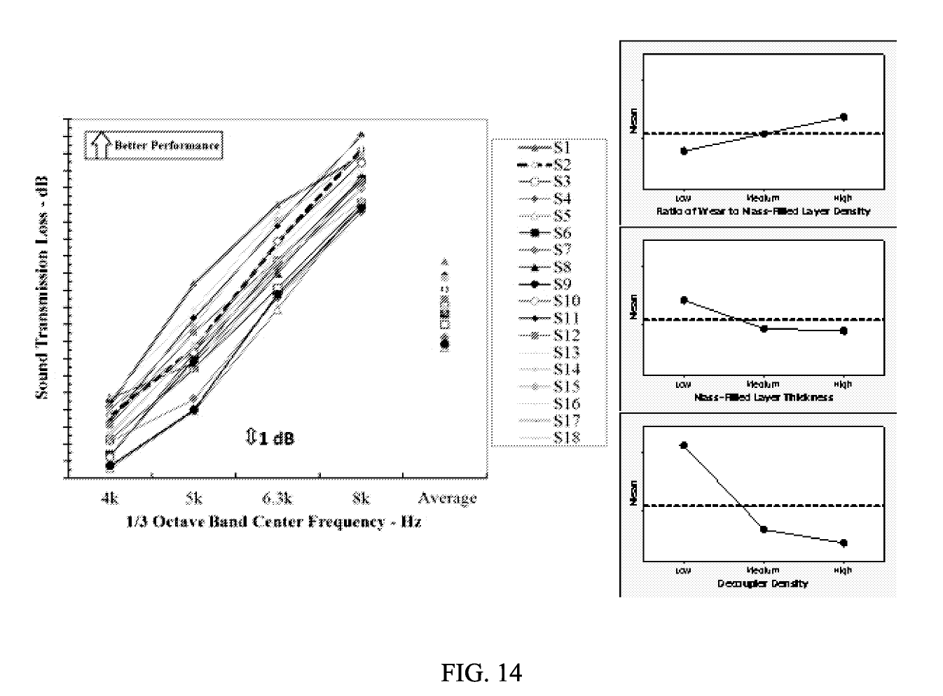

FIGS. 5-16 illustrate another example embodiment of a vehicle flooring system and method that produces a double wall commercial vehicle insulator or liner that provides optimal acoustic and vibration performance, i.e., attenuation. More specifically, the innovation provides a previously unattainable 3D molded design in a double wall floor mat having comparable cost and weight as current extruded flat floor mats. It is to be appreciated that although the system and method disclosed herein is described in relation to vehicle floor mats, the innovation is applicable to any type of insulator or liner, such as but not limited to vehicle door panels, headliners, etc.

FIG. 5 is a perspective view illustrating a conventional commercial vehicle floor mat 500. The conventional floor mat 500 includes a flat bottom surface 502 that has a stiff film on the bottom as a result of the self-skinning effect. This flat surface is installed on the surface of the vehicle floor. This contact creates a conductive path for sound and vibration transmission.

On the other hand, FIG. 6 is a perspective view illustration of the innovative sound and vibration insulator/liner 600. The innovative molded floor mat 600 includes an uneven texturized bottom (or skinned) surface 602. The uneven bottom surface 602 facilitates the reduction or attenuation of acoustics and vibrations as will become apparent from the discussion below. In other words, alternating the bottom surface 602 of the molded (or poured) foam portion of the molded floor mat 600 reduces the normal and transverse strain energy that results in absorption and blocking acoustic and vibration waves. Applying this alternating technique will improve the performance of sound and vibration insulators in any application.

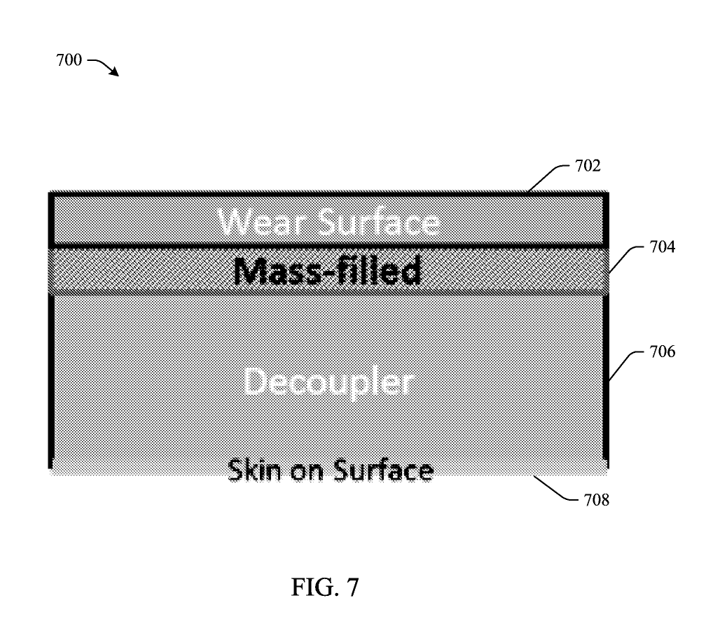

FIG. 7 illustrates a cross-section an example molded floor mat 700 in accordance with an aspect of the innovation. The molded floor mat 700 includes multiple mixtures that may be applied in one or more layers including a wear surface 702, a mass-filled layer 704, and a foam de-coupler 706. The wear surface 702 and mass-filled layer 704 form a first wall of the doubled wall mat. The second wall is formed by the floor of the vehicle. Upon formation of the molded floor mat 700 a skin 708 forms on a bottom of the de-coupler 706. As mentioned above, the skin 708 is in contact with the surface of the vehicle floor and alternating the skinned layer 708 facilitates the attenuation of acoustics and vibration.

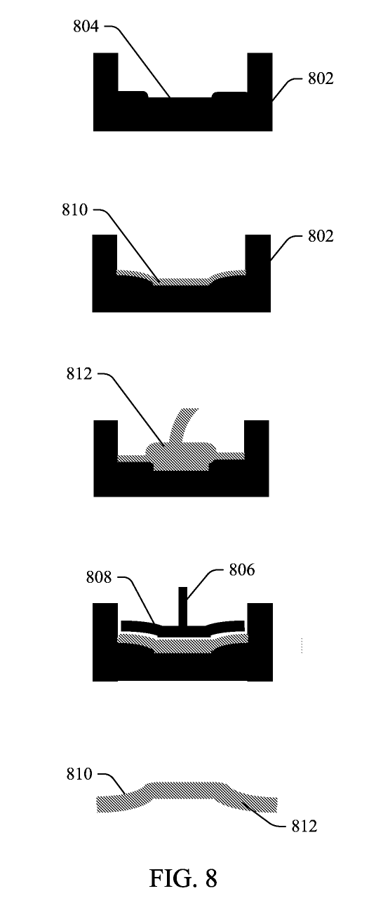

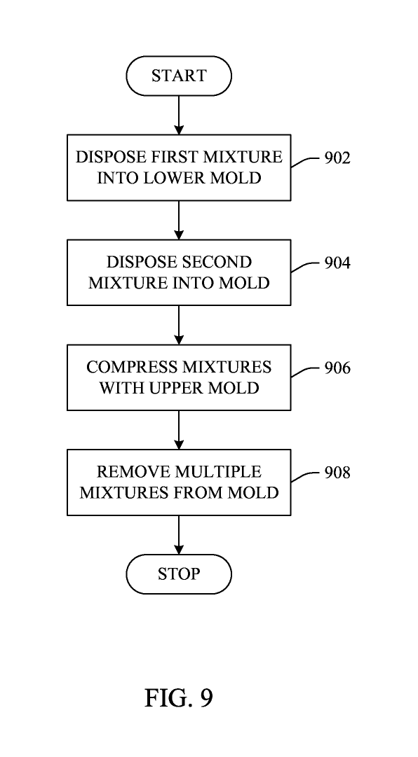

Referring to FIGS. 8 and 9 simultaneously, a method of forming the molded floor mat 700 shown in FIG. 7 will be described. The mold 800 includes a lower mold 802 having an uneven bottom surface 804 and an upper mold 806 having an uneven surface 808 corresponding to the uneven bottom surface 804 of the lower mold 802. At 1002, a first mixture 810 is disposed in the lower mold 802. At 904, a second mixture 812 is disposed into the lower mold 802. At 906, the upper mold 806 compresses the multiple mixtures thereby giving the mixtures 810, 812 the shape of the mold 800. At 908, the multiple mixtures 810, 812 are removed from the mold 800. It is to be appreciated that the innovation is not dependent on the number of mixtures or layers. Thus, the illustration in FIGS. 8 and 9 is for illustrative purposes only and is not intended to limit the scope of the innovation.

For example, although, FIGS. 8 and 9 illustrate the molded floor mat having a first layer and a second layer, it is to be appreciated that in an alternative embodiment, the first and second layers can be applied simultaneously with, for example, a dual tip spray device. In other words, in the method previously described, the first and second layers can be applied in a co-sprayed single layered application. In yet another embodiment, the mixture for the first and second layers may be combined or blended into a single mixture and applied in a single spray application.

In order to determine which of the mixtures or layers noted in FIG. 7 above mostly influence acoustic and vibration performance, a number of experiments were performed with both a flat skinned surface and an uneven skinned surface. A large matrix of parts was produced for various forming, mechanical, and chemical characterization. From that matrix, using experimental planning tools, nine design samples were identified to test for the variation of sound transmission loss (STL) response. The experiments were planned using a Taguchi L-8 Array with two iterations of nine separate trial conditions. This was selected to balance the cost of the sample preparation and testing while still collecting variability information. The STL of the floor mat represents the material's ability to prevent sound from entering a cab of the vehicle. Specifically, STL is the reduction of the amount of sound energy passing into the cab section.

Three factors were considered in the experiment: 1) ratio of wear surface to mass-filled layer density; 2) mass-filled layer thickness; and 3) de-coupler density. One constraint on the total thickness of the part was that any decrease in the layer thickness of the mass-filled layer lead to a proportional increase in the wear surface layer. There were three levels for each factor whose range represented realistic manufacturability.

The predicted double-wall decoupled frequency for a nominal mass sample is 305 Hz. A previous study which showed both theoretically and experimentally that the presence of an air gap, difficult in flooring application, and the method of mounting the foam layer to panel are critical to the STL performance of the double wall system. Furthermore material properties closely related to the solid phase of the foam are much more influential to the STL performance than the fluid phase properties of the foam in the current foam panel boundary condition.

Following indices which are widely in use in DOE methodology are summarized. Standard deviation (SD) in the Taguchi method which is to be minimized is a measure of the variability of the STL response due to noise or uncontrolled effects. Signal to noise ratio (S/N) is a measure of robustness used to identify and optimize the control factors that reduce STL variability of the product by minimizing uncontrolled effects. The index Cₚ is the ratio of the range of the control limits to the six sigma variation of the design which represents dispersion. A related index Cₚₖ measures both the spread and the non-centering of the design.

STL curves were produced in a test facility following recommended practice SAE J1400-10. Samples were mounted between a source reverberation chamber and an adjacent receiving anechoic chamber. These samples were mounted in a sealed frame and were mounted against a metal panel facing the noise source. Differences between the average sound levels in the source and receiving room along with a measured correlation factor lead to the STL curves.

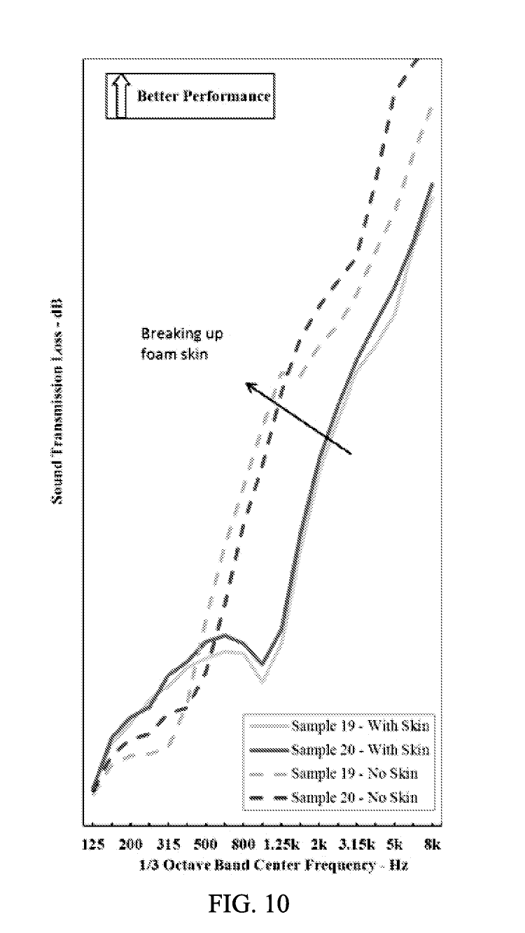

During preparation of the foam de-coupler layer 706 the skin 708 forms against a surface of the mold. The skin 708 largely affects the STL, as shown in FIG. 10. Specifically, FIG. 10 is a graphical illustration demonstration illustrating the improvement in STL from the conventional flat surface floor mat (FIG. 5) to the innovative floor mat (FIG. 6). The solid lines represent the results of the first sample with a flat surface skin and the dotted lines represent the results of the second sample with an uneven skin surface. As clearly shown in the graph, the acoustic and vibration performance of the molded floor mat having an uneven skin surface performs better that the performance of the floor mat having a flat skin surface. Specifically, the double wall frequency clearly shifts from 1000 Hz to 315 Hz, which is near the predicted value of 305 Hz above. This shift is thought to be associated to the interfacial stiffness. Slopes of both curves are similar above the double wall frequency showing that the high frequency acoustical performance is limited by the foam skin.

The STL curve is made up of nineteen ⅓rd octave center band amplitudes ranging from 125 to 8000 Hz. In order to break up the analysis into more manageable sections this frequency range is divided into four ranges shown in Table 1 below.

TABLE 1

| Frequency Range | Frequency | System Behavior |
|---|---|---|
| Range 1 | 125 to 315 Hz | Coupled System |
| Range 2 | 400 to 1000 Hz | Double Wall Resonance Effects |
| Range 3 | 1250 to 3150 Hz | Transition Region |
| Range 4 | 4000 to 8000 Hz | Double Wall Decoupled Region |

A Taguchi analysis demonstrates the optimum performance for each factor and frequency range in Table 2 as well as the influence of a specific factor.

TABLE 2

| | Range 1 | Range 2 | Range 3 | Range 4 |
|---|---|---|---|---|
| | Level - | Level - | Level - | Level - |
| Factor | Influence | Influence | Influence | Influence |
| Ratio of Wear | Medium - | Medium - | High - 3% | High - 7% |
| to Mass-Filled | 3% | 1% | | |
| Layer Density | | | | |
| Mass-Filled | Low - 10% | Low - 3% | Low - 3% | Low - 7% |
| Layer | | | | |
| Thickness | | | | |
| De-coupler | High - 86% | High - 96% | Low - 90% | Low - 77% |
| Density | | | | |

For example, a high density de-coupler is preferable at the lower frequency ranges whereas a low density de-coupler is superior at the two higher frequency ranges. In the current study there are changes in resin chemistry at different foam density levels. The de-coupler density at all 4 frequency ranges has a much larger contribution to the STL response than the other two factors, the effective mass in the top good section of the double wall. Larger mass in the top good section can be achieved through higher loading of the filler material in the mass-filled layer (ratio of wear surface to mass-filled layer density) or by increasing the mass-filled layer thickness whichever is preferential.

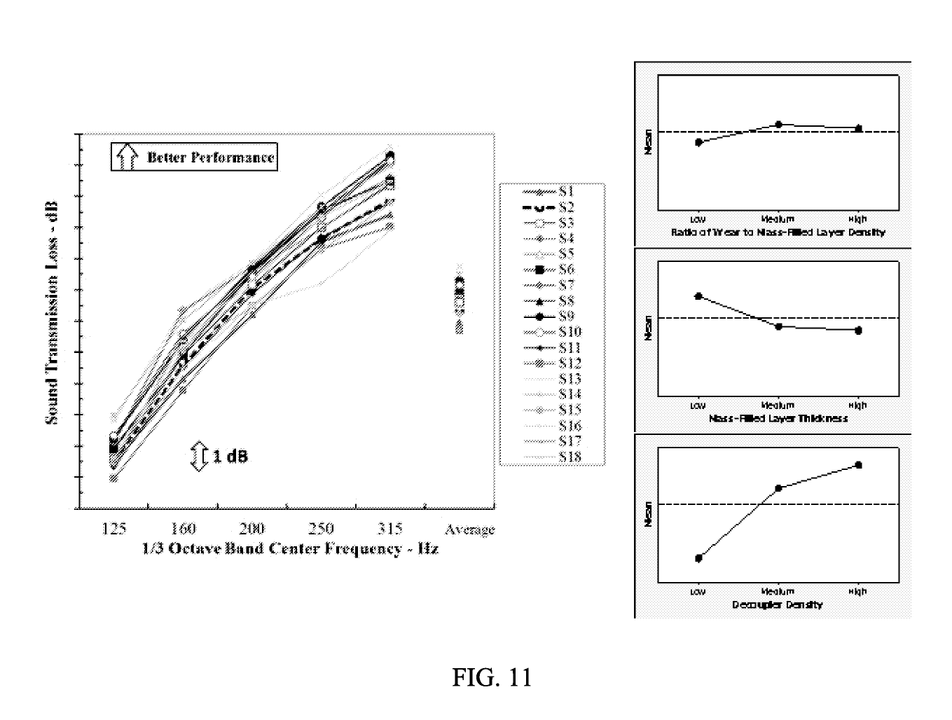

STL response curves are reduced to the main effects of the mean in FIGS. 11 to 14. Larger values in the main effect plot show better acoustical performance. Further greater distance from the grand mean (dashed line) show more influence of the specific factor to STL response. The de-coupler density level reversal from high to low having the largest STL response does not occur with the other two factors, indicating that either of the two methods to increase the effective mass have a positive impact to the acoustical performance.

The interface between the molded floor mat de-coupler skin and the cab structure remains an important area to balance performance trade-offs. Some commercial vehicle manufactures may choose to keep the foam skin if water absorption is a more important concern than acoustical performance. It may be possible to modify this stiffness in the molding process by adding surface texture to the tool. The mechanism by which surface modification shifts the double wall resonance is still being explored, perhaps by effectively adding small air gaps between the foam and cab structure or modifying the localized dynamic stiffness.

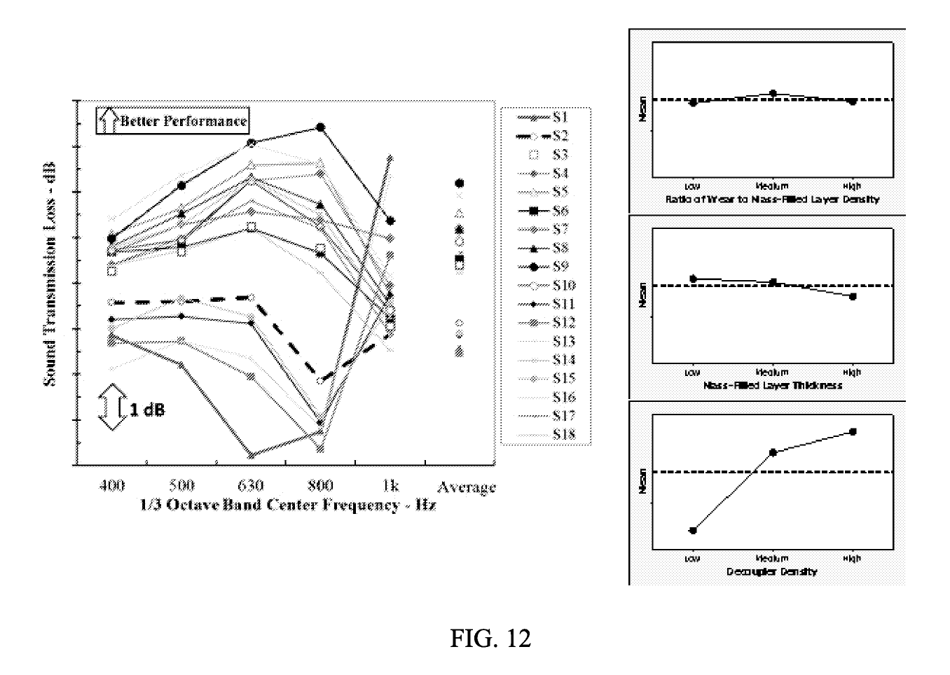

The STL graphs in FIGS. 11, 13, and 14 show a consistent amplitude spread, while the inconsistency in FIG. 12 is due to the shifting double wall frequencies, most at either 800 or 1000 Hz. The main effects plots show that the most dominant factor at all frequency ranges is the foam density. The mass law slopes of the STL curve shown in FIGS. 8 and 9, approximately 6 dB per octave, indicate that the system is system is mass controlled and higher density foam performs better. However, in FIGS. 10 and 11, the decoupled system has much greater STL slopes, and lowest density foam has the highest STL response.

The design variation is optimized with respect to a specific target. This target usually takes the form of a STL curve, but is easily converted to an average value in a frequency range as previously described. For illustrative purposes, the improved design target for frequency range 4 is 3 dB greater than the current design average: Improved Design_{average,R4}=Current Design_{average,R4}+3 [dB]. It is expected that the improved design can be achieved with the same optimum levels from Table 1 and the Signal to Noise (S/N) Ratio in Table 3 below.

TABLE 3

| Factor | Signal to Noise Ratio |
|---|---|
| Ratio of Wear to Mass- | −7.90 |
| Filled Layer Density | |
| Mass-Filled Layer | −8.19 |
| Thickness | |
| Decoupler Density | −4.48 |

The current design (S/N Ratio: −9.4, SD: 7.4, Cp: 1, Cpk: 0.86) is improved significantly to the improved design (S/N Ratio: −1.7, SD: 3.1, Cp: 2.4, Cpk: 2.4). Optimizations can be further improved with cost models to customize the design depending on the needed acoustical improvement in each frequency range balanced with the cost of increasing weight, raw material, or manufacturing.

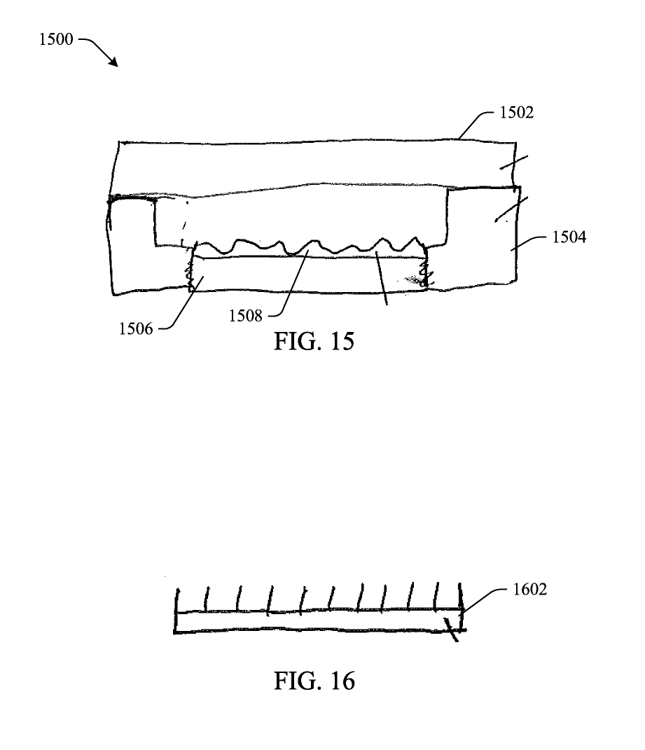

FIG. 15 is another example embodiment of a mold 1500 having an upper mold 1502, a lower mold 1504, and a texturized tool insert 1506. The texturized tool 1506 has a texturized surface 1508 to create a molded floor mat having a texturized bottom surface. The texturized portion of the bottom surface may have a depth ranging from 0.1 to 0.2 mm.

FIG. 16 is an example embodiment of a perfing tool 1602 used to create an uneven bottom surface of a molded flooring mat. The perfing tool 1602 can be inserted into the lower mold or can be used an as after mold tool to create the uneven bottom surface.

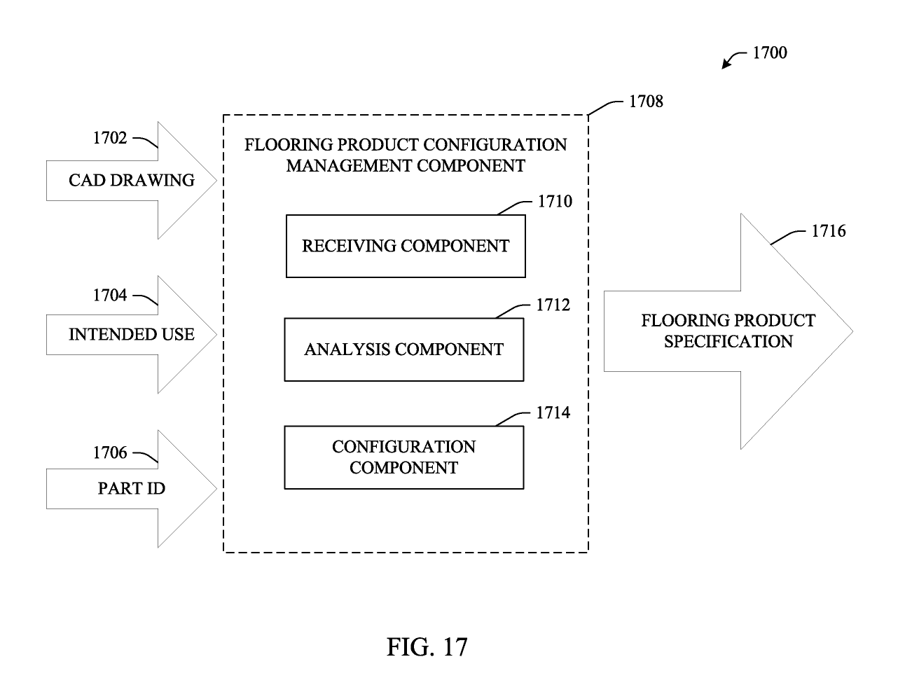

With reference to FIG. 17, it will be appreciated that the molded floor mat can be automatically designed using computer automation. Specifically, a flooring mat specification or design may be obtained with the analysis of various parameters input into a computer system 1700. For example, some but not all input parameters may include information from a CAD drawing 1702, the intended use 1704 of the part, part identification 1706, etc. Information from the CAD drawing 1702 may include dimensions, locations of holes, cutouts, bends, etc. Intended use 1704 may include information such as where the part will be installed in the vehicle, orientation of the part, how the part will interface with other parts in the vehicle, etc. The part identification 1806 may include a part number, part description, the weight of the part, etc.

The input parameters may be input into a flooring product configuration management component 1708 of the computer system 1700 where the information is processed. The flooring product configuration management component 1708 may include several processing components, such as but not limited to a receiving component 1710, an analysis component 1712, and a configuration component 1714. The receiving component 1710 receives the information from the input parameters and sends the input information to the appropriate component within the flooring product configuration management component 1708. The analysis component 1712 analyzes the information from the input parameters to determine an optimum flooring product configuration. Finally, the configuration component 1714 configures the flooring product based on the resulting information from the analysis component 1712.

The information from the flooring product configuration management component 1708 is output in the form of a specification. For example, the optimum flooring product configuration may be output in the form of a flooring product specification 1716, which is used to fabricate the part.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle flooring system comprising:
a single-sided mold component; and
a spray application component that facilitates application of a liquefied mixture into the single-sided mold, wherein the application results in a vehicle flooring product.

2. The vehicle flooring system of claim 1, wherein the liquefied mixture is a 100% blend of urea that includes a percentage of barium sulfate (BaSO4).

3. The vehicle flooring system of claim 1, wherein a foil is molded-in upon application of the liquefied mixture, and wherein the foil provides heat deflection from a passenger compartment of the vehicle.

4. The vehicle flooring system of claim 1, wherein the single-sided mold component has a draft angle of approximately 90 degrees.

5. The vehicle flooring system of claim 1, wherein the single-sided mold component has a top surface having at least one surface treatment.

6. The vehicle flooring system of claim 5, wherein the at least one surface treatment is a logo and/or ridges and/or a grain structure.

7. The vehicle flooring system of claim 6, wherein the flooring product is a floor mat.

8. The vehicle flooring system of claim 1, wherein carpet is disposed in localized areas of a top surface of the vehicle flooring product.

9. The vehicle flooring system of claim 8, wherein the amount of liquefied mixture applied to the localized areas containing carpet is less than the amount of liquefied mixture applied to other portions of the vehicle flooring product.

10. A method for forming a vehicle flooring product comprising:
providing a single-sided mold;
spraying a liquefied mixture into the single-sided mold;
curing the liquefied mixture for a pre-determined amount of time; and
removing the cured mixture from the single sided mold, wherein the cured mixture is the vehicle flooring product.

11. The vehicle flooring system of claim 10, wherein the liquefied mixture is a 100% blend of urea that includes a percentage of barium sulfate (BaSO4).

12. The method of claim 10, further comprising inserting a foil into the single-sided mold, wherein the foil is molded-in upon spraying of the liquefied mixture, and wherein the foil provides heat deflection from a passenger compartment.

13. The method of claim 10, wherein the single-sided mold has a draft angle of approximately 90 degrees.

14. The method of claim 10, wherein the single-sided mold has a top surface having at least one surface treatment, wherein the at least one surface treatment is a logo and/or ridges and/or a grain structure.

15. The method of claim 10, wherein carpet is disposed in localized areas of a top surface of the vehicle flooring product, and wherein the amount of liquefied mixture applied to the localized areas containing carpet is less than the amount of liquefied mixture applied to other portions of the vehicle flooring product.

16. A molded insulator for a vehicle comprising:
a first mixture; and
a second mixture disposed on the first mixture;
wherein the second mixture has a textured bottom surface to facilitate attenuation of sound and/or vibration.

17. The molded insulator of claim 16, wherein the first mixture and the second mixture are applied in separate spray applications, such that the first mixture creates a first layer and the second mixture creates a second layer, and wherein the first layer includes a wear surface and a mass-filled layer.

18. The molded insulator of claim 16, wherein the first mixture and the second mixture are applied simultaneously co-sprayed to form a single layer.

19. The molded insulator of claim 16, wherein the first mixture and the second mixture are combined into a single mixture and applied as a single layer.

20. The molded insulator of claim 16, wherein the second mixture is a de-coupler that includes foam and a skin formed on the bottom surface of the foam, and wherein the insulator is a molded floor mat.
